(19) United States
(12) Patent Application Publication
(10) Pub. No.: US 2008/0191990 A1
(43) Pub. Date: Aug. 14, 2008

(54) DRIVER AND DISPLAY METHOD USING THE SAME

(75) Inventors: Hiroyuki MATSUBARA, Kanagawa (JP); Hiroyuki TAKAHASHI, Kanagawa (JP); Nobuyuki ORITA, Kanagawa (JP); Toshiharu OKAMOTO, Kanagawa (JP); Shuuichi SENOU, Kanagawa (JP)

Correspondence Address: Young & Thompson, Second Floor, 745 S. 23rd Street., Arlington, VA, 22202, US

(73) Assignee: NEC ELECTRONICS CORPORATION, Kawasaki (JP)

(21) Appl. No.: 12/026,613

(22) Filed: Feb. 6, 2008

(30) Foreign Application Priority Data
Feb. 8, 2007 (JP) 2007-028723
Dec. 27, 2007 (JP) 2007-337633

(51) Int. Cl. G09G 3/36

(52) U.S. Cl. 345/98

(57) ABSTRACT

A driver includes a first memory including a plurality of memory cells and redundant memory cells. An address control circuit replaces a defective memory cell of the plurality of memory cells with one of the redundant memory cells based on a defect address data indicating an address of the defective memory cell. A driving circuit displays on a display panel, a display data stored in the first memory based on a display quality specifying data specifying display quality of the display panel. The display quality specifying data and the defect address data are stored in a second memory.

### BACKGROUND OF THE INVENTION

1. Field of the Invention

The present invention relates to a driver to which a display panel is connected. This patent application is based on Japanese Patent Application Nos. 2007-028723 and 2007-337633. Their disclosures are incorporated herein by reference.

2. Description of Related Art

A portable terminal such as a mobile phone and a PDA (Personal Digital Assistant) has widespread. A display apparatus with a driver and a display panel is provided for the portable terminal, and a LCD (Liquid Crystal Display) panel is generally adopted as the display panel.

The driver has a dedicated device for holding data, a program control circuit, and a memory for storing a display data. The program control circuit records a display quality specifying data in the dedicated device. The driver displays the display data stored in the memory on the display panel based on the display quality specifying data recorded in the dedicated device. Such a technique is disclosed in Japanese Patent Application Publications (JP-P2003-241730A, and JP-P2004-21067A: first and second conventional examples). In the first conventional example, EEPROM is exemplified as the dedicated device and in the second conventional example, a jumper switch circuit, EPROM, and EEPROM are exemplified as the dedicated device.

The driver sometimes includes a dedicated device used for other applications other than the dedicated device for holding display quality specifying data. In such a case that a plurality of program control circuits are associated with a plurality of dedicated devices, a circuit size of the driver as a whole increases due to the plurality of program control circuits.

### SUMMARY

In an aspect of the present invention, a driver includes a first memory including a plurality of memory cells and redundant memory cells. An address control circuit replaces a defective memory cell of the plurality of memory cells with one of the redundant memory cells based on a defect address data indicating an address of the defective memory cell. A driving circuit displays on a display panel, a display data stored in the first memory based on a display quality specifying data specifying display quality of the display panel. The display quality specifying data and the defect address data are stored in a second memory.

In another aspect of the present invention, a display apparatus includes the above-mentioned driver and a display panel connected with the driver.

In another aspect of the present invention, a display method of displaying a display data stored in a first memory on a display panel by using a driver which comprises memory cells and redundant memory cells is provide. The display method includes storing a display quality specifying data and a defect address data indicating an address of a defective one of the memory cells, in a second memory; replacing the defective memory cell with one of the redundant memory cells based on the defect address data; and displaying the display data on the display panel based on the display quality specifying data.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram showing a configuration of a display system to which a driver according to a first embodiment of the present invention is applied;

FIG. 2 a diagram showing a flash memory as a nonvolatile memory of FIG. 1;

FIG. 3 is a flowchart showing an operation of a program control circuit of FIG. 1;

FIG. 4 is a diagram showing electric fuses as the nonvolatile memory in the driver according to the second embodiment of the present invention;

FIG. 5 is a block diagram showing the configuration of the display system to which the driver 1 according to a third embodiment of the present invention is applied;

FIG. 6 is a flow chart showing an operation of a BIST circuit of FIG. 5 and a program control circuit;

FIG. 7 is a block diagram showing a configuration of the display system to which the driver according to a fourth embodiment of the present invention is applied;

FIG. 8 is a flowchart showing an operation of the power-on monitoring circuit, the BIST circuit, and the program control circuit;

FIG. 9 is a block diagram showing a configuration of the display system to which the driver acceding to a fifth embodiment of the present invention is applied;

FIG. 10 is a flowchart showing an operation of the program control circuit to an input unit;

FIG. 11 shows a configuration of the display system to which the driver acceding to a sixth embodiment of the present invention is applied;

FIG. 12 is a diagram showing an access right to first and second display quality specifying data storage sections and a defect address data storage section;

FIG. 13 is a diagram showing a read operation when a power supply voltage is supplied to the driver from a power source;

FIG. 14 is a block diagram showing an automatic power-on read operation by the driver according to the sixth embodiment of the present invention;

FIG. 15 is a flow chart showing an operation of a power-on monitoring circuit, the program control circuit, and a sense amplifier circuit;

FIG. 16 is a diagram showing a write operation of the driver 1 according to a seventh embodiment of the present invention;

FIG. 17 is a flow chart showing an operation of the program control circuit;

FIG. 18 is a diagram showing a read operation of the driver according to the seventh embodiment of the present invention;

FIG. 19 is a flow chart showing an operation of the program control circuit and a sense amplifier circuit in FIG. 18;

FIG. 20 is a block diagram showing a read operation of the driver according to the eighth embodiment of the present invention;

FIG. 21 is a flow chart showing an operation of the program control circuit of FIG. 20;

FIG. 22 is a block diagram showing an erase operation of the driver according to the ninth embodiment of the present invention; and

FIG. 23 is a flow chart showing the operation of the program control circuit 50 of FIG. 22.

### DESCRIPTION OF THE PREFERRED EMBODIMENTS

Hereinafter, a driver according to embodiments of the present invention will be described in detail with reference to the attached drawings.

### First Embodiment

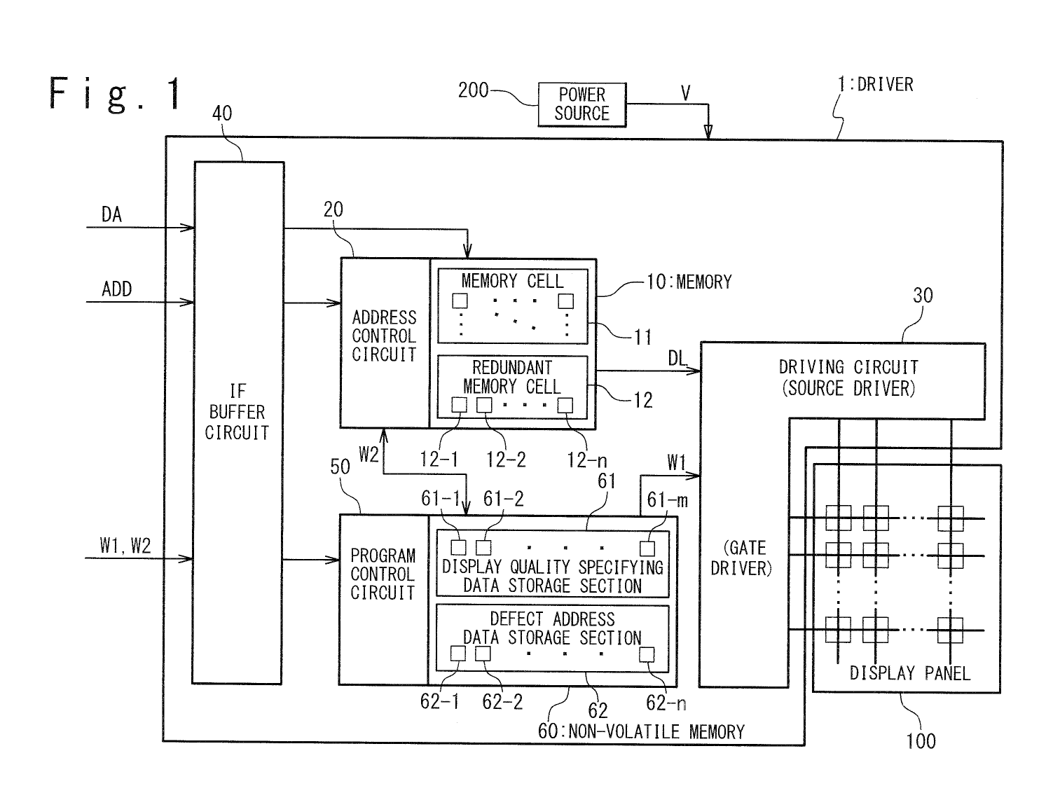

FIG. 1 is a block diagram showing a configuration of a display system to which a driver 1 according to a first embodiment of the present invention is applied. This display system has the driver 1, a display panel 100 and a power supply 200. The power supply 200 supplies power supply voltage V to the driver 1. An LCD (Liquid Crystal Display) panel is exemplified as the display panel 100.

The driver 1 includes a memory 10, an address control circuit 20, a driving circuit 30, an interface (IF) buffer circuit 40, a program control circuit 50, and a nonvolatile memory 60.

The IF buffer circuit 40 is an interface connected to the memory 10, the address control circuit 20, the program control circuit 50, and an external unit.

The memory 10 includes memory cells 11 and redundant memory cells 12-1 to 12-n (n is an integer of “1” or more), which are arranged on a matrix. Here, the redundant memory cell may be single. As the memory, DRAM (Dynamic Random Access The memory) and SRAM (Static Random Access The memory) are exemplified.

The nonvolatile memory 60 has a display quality specifying data storage section 61 and a defect address data storage section 62. The display quality specifying data storage section 61 includes storage areas 61-1 to 61-m (m is an integer of “1” or more) and the defect address data storage section 62 includes storage areas 62-1 to 62-n. The storage areas 62-1 to 62-n of the defect address data storage section 62 correspond to the storage areas 61-1 to 61-n of the redundant memory cells 12-1 to 12-n.

The program control circuit 50 operates in synchronization with a clock signal (in this case, an internal clock signal). For example, a display quality specifying data W1 that specifies display quality of the display panel 100 is given from an external unit to the program control circuit 50 through the IF buffer circuit 40. In this case, the program control circuit 50 records the display quality specifying data W1 in a storage area 61-i (i is an integer satisfying 1≦i≦m) of the display quality specifying data storage section 61 of the nonvolatile memory 60. For example, it is supposed that each of the memory cells 11 is tested and at least one memory cell among the memory cells 11 is defective. In this case, a defect address data W2 showing the address of the defective memory cell is given from the external unit to the program control circuit 50 through the IF buffer circuit 40. At this time, the program control circuit 50 records the defect address data W2 in a storage area 62-j (j is an integer satisfying 1≦j≦n) of the defect address data storage section 62 of the nonvolatile memory 60. In this way, the display quality specifying data W1 and the defect address data W2 are recorded by using a same storage method.

The address control circuit 20 operates in synchronization with the internal clock signal. The address control circuit 20 replaces defective memory cells 11 with redundant memory cells 12-j based on the defect address data W2 recorded in the storage areas 62-j of the defect address data storage section 62. A display data DA is stored in the memory 10 from the external unit through the IF buffer circuit 40, and an address ADD for displaying one display line on the display panel 100 is given from the external unit to the address control circuit 20 through the IF buffer circuit 40. In this case, the address control circuit 20 outputs display data DL of the display data DA stored in the memory 10, which corresponds to one display line, to the driving circuit 30.

The driving circuit 30 operates in synchronization with the internal clock signal, and has a source driver and a gate driver. The driving circuit 30 displays the display data DL on the display panel 100 based on the display quality specifying data W1 recorded in the display quality specifying data storage section 61.

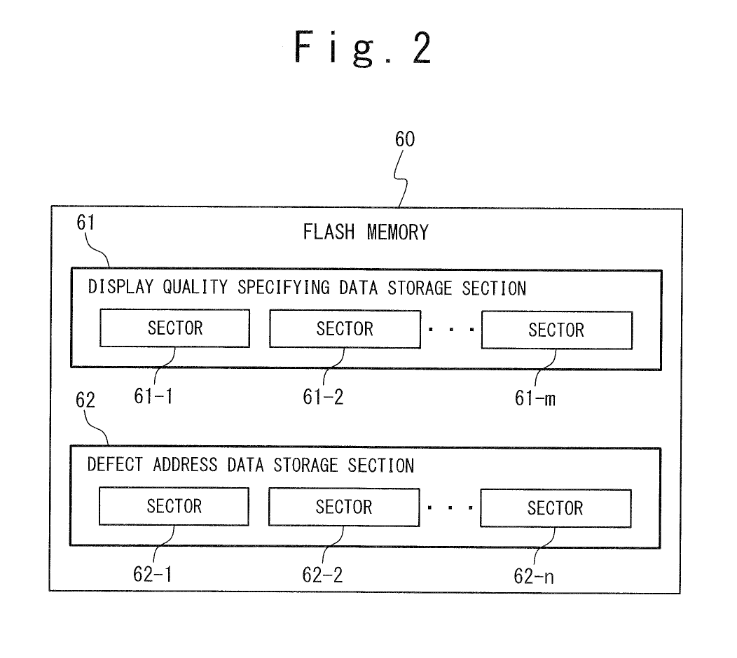

The nonvolatile memory 60 is either of a flash memory, EPROM, or EEPROM. As shown in FIG. 2, in the present embodiment, it is assumed that the nonvolatile memory 60 is the flash memory, and each of the storage areas of the display quality specifying data storage section 61 and the storage areas of the defect address data storage section 62 is a sector.

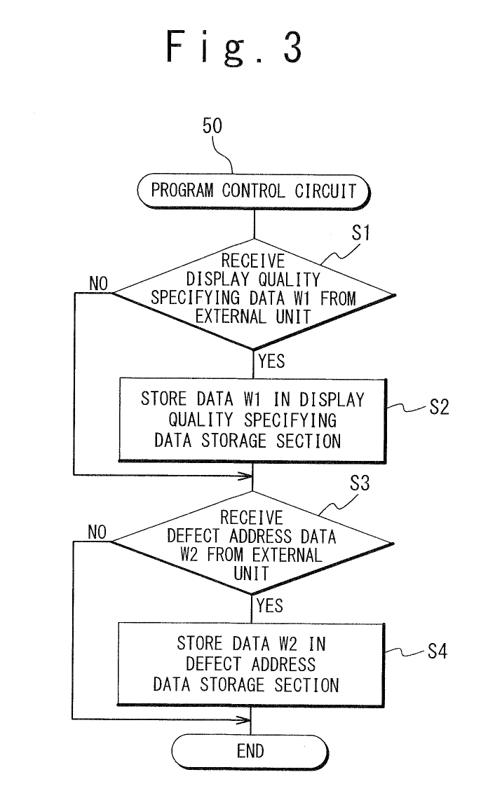

FIG. 3 is a flowchart showing an operation of the program control circuit 50.

The display quality specifying data W1 is given from the external unit to the program control circuit 50 through the IF buffer circuit 40 (Step S1—YES). In this case, the program control circuit 50 selects a n empty one 61-i of the storage areas of the display quality specifying data storage section 61 of the nonvolatile memory 60 and records the display quality specifying data W1 in the selected storage area 61-i (Step S2). As the display quality specifying data W1, data about fine control of display contrast is exemplified. For example, when the display quality specifying data W1 is a data about adjustment of a counter electrode signal VCOM, the data is recorded in the storage area 61-1 of the display quality specifying data storage section 61. When the display quality specifying data W1 is a data about adjustment of a setup value of an LCD driving voltage, the data is recorded in the storage area 61-2 of the display quality specifying data storage section 61. By providing m display quality specifying data storage areas 61-1 to 61-m, m display quality specifying data W1 can be recorded in the display quality specifying data storage areas 61-1 to 61-m, respectively.

As a test result of each of the plurality of memory cells 11, the defect address data W2 designating the address of a defective one of the memory cells 11 is given from the external unit to the program control circuit 50 through the IF buffer circuit 40 (Step S3—YES). In this case, the program control circuit 50 selects an empty one 62-j of the storage areas of the defect address data storage section 62 of the nonvolatile memory 60 and records the defect address data W2 in the selected area 62-j (Step S4). Since the areas 62-1 to 62-n of the defect address data storage section 62 correspond to the redundant memory cells 12-1 to 12-n, respectively, n defect address data W2 can be recorded in the defect address data storage areas 62-1 to 62-n.

It should be noted that a pair of the steps S1 and S2 and a pair of the steps S3 and S4 are in no particular order.

As described above, the driver 1 according to the first embodiment of the present invention records the display quality specifying data W1 and the defect address data W2 by using the same storage method by the program control circuit 50. This eliminates the necessity of separately fabricating a dedicated device for recording the display quality specifying data W1 and a dedicated device for recording the defect address data W2. Moreover, if the dedicated devices are fabricated separately, circuit scale of the program control circuit 50 becomes large. However, in the present embodiment, because there is no necessity to separately fabricate the dedicated devices, a function of recording the display quality specifying data W1 and a function of recording the defect address data W2 can be made common by the program control circuit 50. As such, the circuit scale of the program control circuit 50 can be reduced, and the circuit scale of the whole driver 1 can also be reduced.

Moreover, the driver 1 of the present invention adopts a flash memory functioning as the nonvolatile memory 60, whose programming method does not adopt laser trimming fuses. When the laser trimming fuse is adopted, it is necessary to provide an opening window for allowing a laser beam to be irradiated on the laser trimming fuse in the driver 1. In such a case, there is a possibility that dust enters in the driver 1 from the outside through the opening window, depending on the mounting process. If dust has accidentally entered, it raises the possibility of causing a short-circuit in the driver 1 during operations after the mounting. On the other hand, when the flash memory is adopted, it is unnecessary to provide the opening window for the driver 1. Moreover, in the flash memory, the display quality specifying data W1 and the defect address data W2 can be recorded by sending the data into the driver 1, not by irradiating the laser light in the driver 1. Therefore, it is possible to program the display device 1 after the mounting.

Moreover, in the driver 1 according to the present embodiment, when the memory 10 is a DRAM as an application of a program for the memory 10, it is possible to relieve the defective memory cell due to degradation of a cell hold property after the mounting.

### Second Embodiment

In the driver according to a second embodiment of the present invention, duplicate description with that in the first embodiment would be omitted.

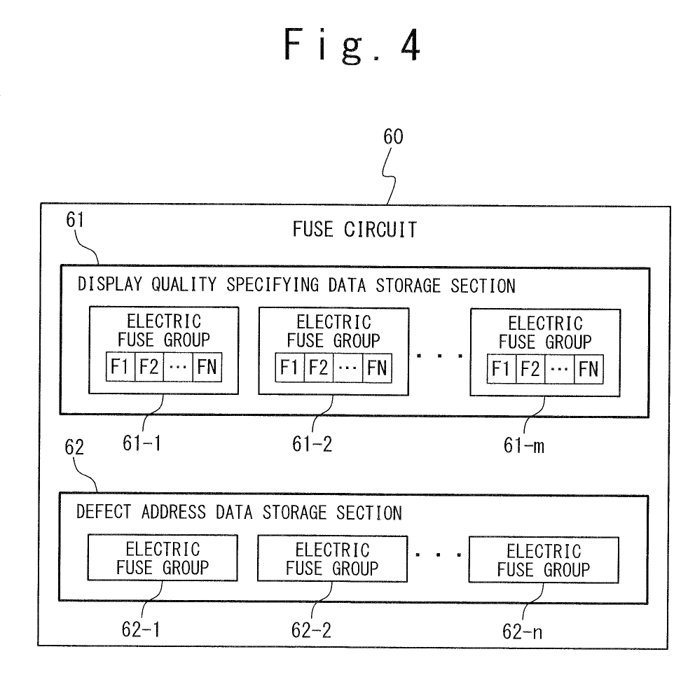

As shown in FIG. 4, the nonvolatile memory 60 is composed of electrical fuses instead of current fusing type fuses. In the second embodiment, it is assumed that each of the storage areas 61-1 to 61-m of the display quality specifying data storage section 61 and the storage areas 62-1 to 62-n of the defect address data storage section 62 includes a group of electrical fuses F1 to FN (N is an integer of “1” or more).

The display quality specifying data W1 is given from the external unit to the program control circuit 50 through the IF buffer circuit 40 (Step S1—YES). In this case, the program control circuit 50 supplies current to the electrical fuses to be cut off among the group of electrical fuses F1 to FN in the storage area 61-i of the display quality specifying data storage section 61 of the nonvolatile memory 60, to record the display quality specifying data W1 in the storage area 61-i (Step S2). For example, it is supposed that N is 12 and the electrical fuses to be cut off are F9 to F11. In this case, each of the electrical fuses F1 to F8 being not cut off represents “0,” and each of the cut-off electrical fuses F9 to F11 represents “1.” Thus, the program control circuit 50 records the display quality specifying data W1 in the group of electrical fuses F1 to FN in the storage area 61-i.

As a test result of each of the plurality of memory cells 11, the defect address data W2 designating the address of the defective one of the plurality of memory cells 11 is given from the external unit to the program control circuit 50 through the IF buffer circuit 40 (Step S3—YES). In this case, the program control circuit 50 supplies current to the electrical fuses to be cut off among the group of electrical fuses F1 to FN in the storage area 62-j of the defect address data storage section 62 of the nonvolatile memory 60, to record the defect address data W2 in the storage area 62-j (Step S4). For example, it is supposed that N is 12 and the electrical fuses to be cut off are F9 to F11. In this case, each of the electrical fuses F1 to F8 being not cut off represents “0,” and each of the cut-off electrical fuses F9 to F11 represents “1.” Since the storage areas 62-1 to 62-n of the defect address data storage section 62 respectively correspond to the redundant memory cells 12-1 to 12-n, n defect address data W2 can be recorded in the defect address data storage areas 62-1 to 62-n.

As described above, the driver 1 of the present invention adopts the groups of electrical fuses F1 to FN as one storage area of the nonvolatile memory 60, whose programming method does not adopt laser trimming fuses. If the laser trimming fuse is adopted, it is necessary to provide an opening window for allowing the laser light to be irradiated on the laser trimming fuse for the driver 1. In this case, there is a possibility that dust enters in the driver 1 from the outside through the opening window, depending on the mounting process. If the dust has accidentally entered, it raises the possibility of causing a short-circuit in the driver 1 during operations after the mounting. On the other hand, in the group of electrical fuses F1 to FN, it is unnecessary to provide the opening window in the driver 1. Moreover, the display quality specifying data W1 and the defect address data W2 can be recorded by sending data into the driver 1 and cutting the electrical fuses that correspond to the data, not by irradiating the laser light in the driver 1. Therefore, it is possible to program the driver 1 after the mounting.

### Third Embodiment

In the driver according to a third embodiment of the present invention, duplicate description with those of the first and second embodiments would be omitted.

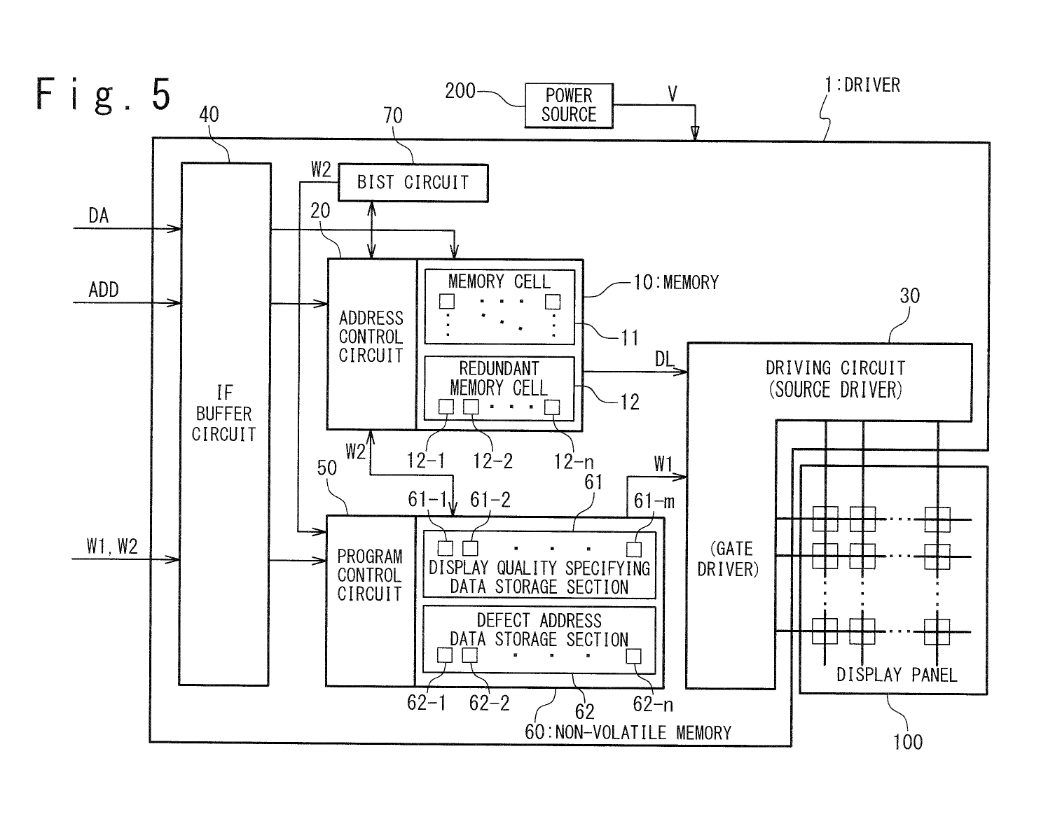

FIG. 5 shows a configuration of the display system to which the driver 1 according to the third embodiment of the present invention is applied. The driver 1 is further provided with a BIST (Built-In Self-Test) circuit 70. The BIST circuit 70 operates in synchronization with the internal clock signal.

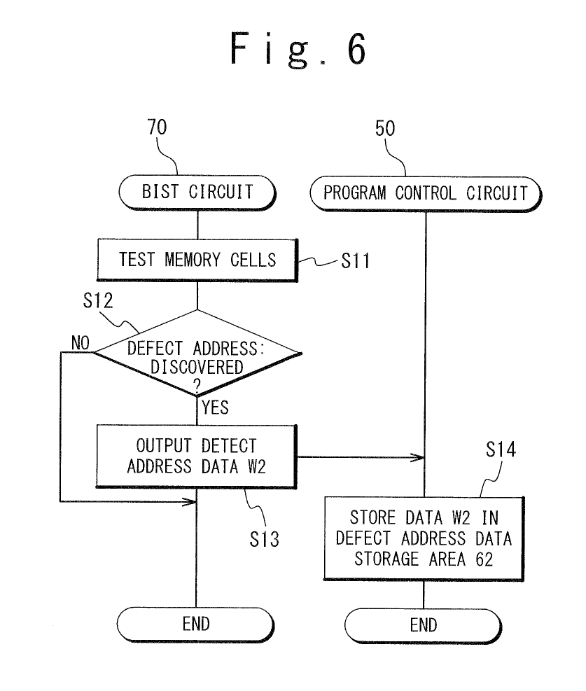

FIG. 6 is a flowchart showing an operation of the BIST circuit 70 and the program control circuit 50. The BIST circuit 70 tests each of the plurality of memory cells 11 (Step S11). At least one memory cell among the plurality of memory cells 11 is supposed to be a defective memory cell (Step S12—YES). In this case, the BIST circuit 70 outputs the defect address data W2 designating the address of the defective memory cell to the program control circuit 50 (Step S13). At this time, the program control circuit 50 executes the step S4 described above (Step S14). That is, the program control circuit 50 receives the defect address data W2 from the BIST circuit 70, selects an empty storage area 62-j of the defect address data storage section 62 and records the defect address data W2 in the selected storage area 62-j of the nonvolatile memory 60. In this way, the driver 1 of the present invention can realize a self restoring function, as an application of a program for the memory 10.

### Fourth Embodiment

In the driver 1 according to a fourth embodiment of the present invention, duplicate description with those of the first to third embodiments would be omitted.

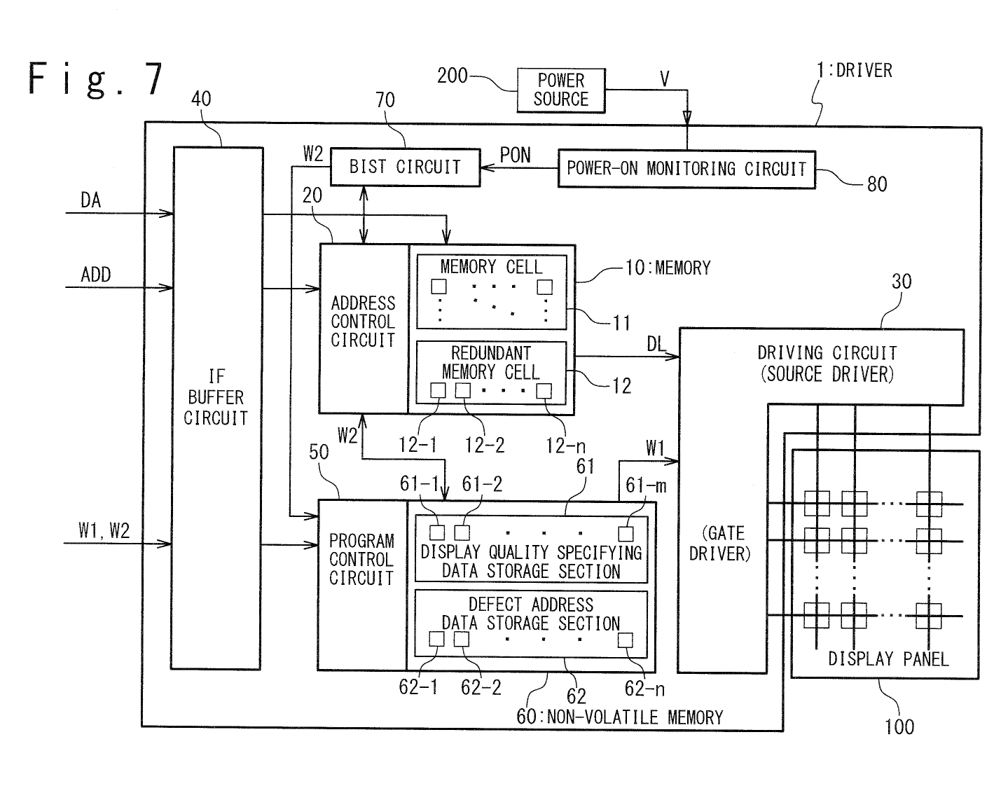

FIG. 7 shows a configuration of the display system to which the driver 1 according to the fourth embodiment of the present invention is applied. The driver 1 is further provided with a power-on monitoring circuit 80.

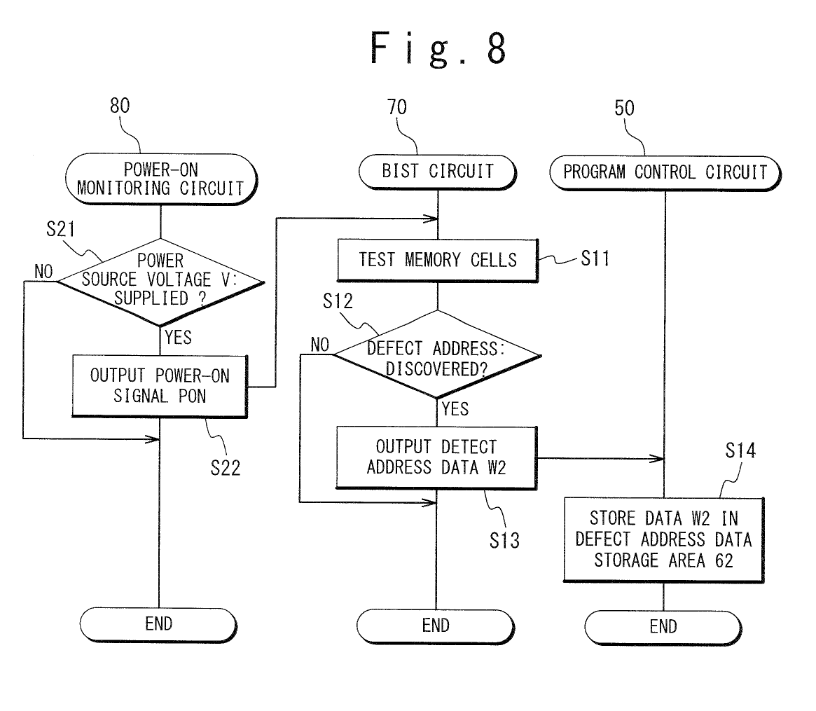

FIG. 8 is a flowchart showing an operation of the power-on monitoring circuit 80, the BIST circuit 70, and the program control circuit 50.

The power-on monitoring circuit 80 monitors the power source 200 (Step S21). When power supply voltage V is supplied from the power source 200 to the driver 1 (step S21—YES), the power-on monitoring circuit 80 outputs a power-on signal PON to the BIST circuit 70 (Step S22). At this time, the steps S11 to S14 described above are executed. That is, in response to the power-on signal PON, the BIST circuit 70 tests each of the plurality of memory cells 11 (Step S11), and outputs the defect address data W2 designating the address of the defective memory cell to the program control circuit 50 (Step S13). The program control circuit 50 records the defect address data W2 in an empty storage area 62-j of the storage areas of the defect address data storage section 62 of the nonvolatile memory 60 (Step S14). In this way, the driver 1 according to the fourth embodiment of the present invention can realize a self restoring function in a final product by combining a power-on self-test and the operations, as an application of the program for the memory 10.

### Fifth Embodiment

In a fifth embodiment of the present invention, duplicate description with those of the first to fourth embodiments would be omitted.

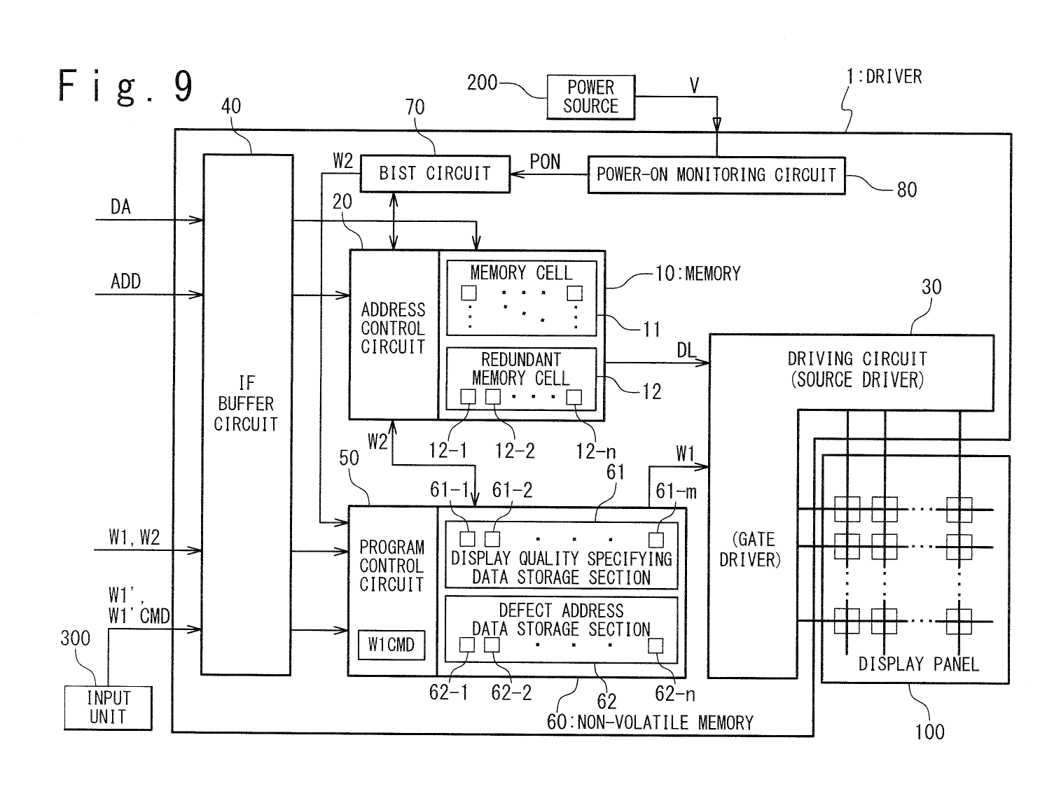

FIG. 9 shows a configuration of the display system to which the driver 1 acceding to the fifth embodiment of the present invention is applied. This system is further provided with an input unit 300.

The display quality represented by the display quality specifying data W1 can be altered by the user operating the input unit 300. At this time, what is required is that the user records the display quality specifying data W1 in the display quality specifying data storage section 61 of the nonvolatile memory 60. However, it is undesirable that the user records it erroneously in the defect address data storage section 62 of the nonvolatile memory 60. Moreover, a case is more undesirable that the display quality specifying data storage section 61 and the defect address data storage section 62 are each made up of the group of electrical fuses F1 to FN (current fusing type fuses), and the display quality specifying data W1 is erroneously recorded in the defect address data storage section 62.

From the above situation, in the fifth embodiment, the user is given an access right to the display quality specifying data storage section 61, but is not given the access right to the defect address data storage section 62. In this case, the program control circuit 50 holds the access right command W1CMD showing the access right to the display quality specifying data storage section 61. An operation related to this will be described.

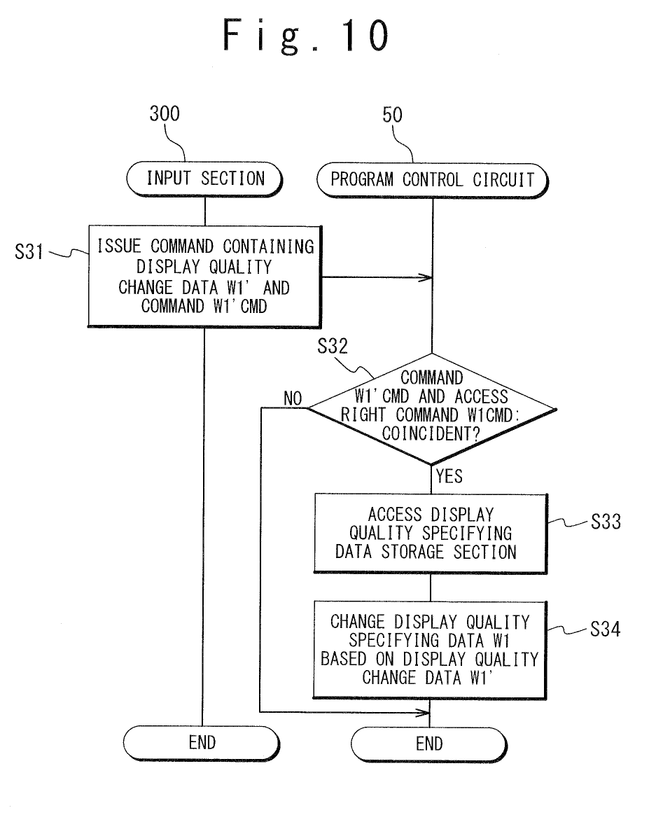

FIG. 10 is a flowchart showing an operation of the program control circuit 50 to the input unit 300. The user operates the input unit 300 to give an instruction including a display quality change data W1′ representing an change of display quality and a command W1′CMD to the program control circuit 50 through the IF buffer circuit 40 (Step S31). In this case, the program control circuit 50 collates the command W1′CMD included in the instruction with the access right command W1CMD held by the program control circuit 50 (Step S32). When the command W1′CMD and the access right command W1CMD coincide with each other (Step S32—YES), the program control circuit 50 accesses the display quality specifying data storage section 61 (Step S33), and updates the display quality specifying data W1 based on the display quality change data W1′ included in the instruction (Step S34). In this way, the driver 1 according to the fifth embodiment of the present invention makes it possible for the user to record the display quality specifying data W1 in the display quality specifying data storage section 61 of the nonvolatile memory 60, as an application of a program for the display panel 100. Thus, the user can change the display quality to one that the user prefers. Moreover, the driver 1 can guarantee the specification of the driver 1 by configuring it to give the user an access right to display quality specifying data storage section 61 of the nonvolatile memory 60, and not to give the user an access right to the defect address data storage section 62.

### Sixth Embodiment

In the description of a sixth embodiment of the present invention, duplicate description with those of the first to fifth embodiments would be omitted.

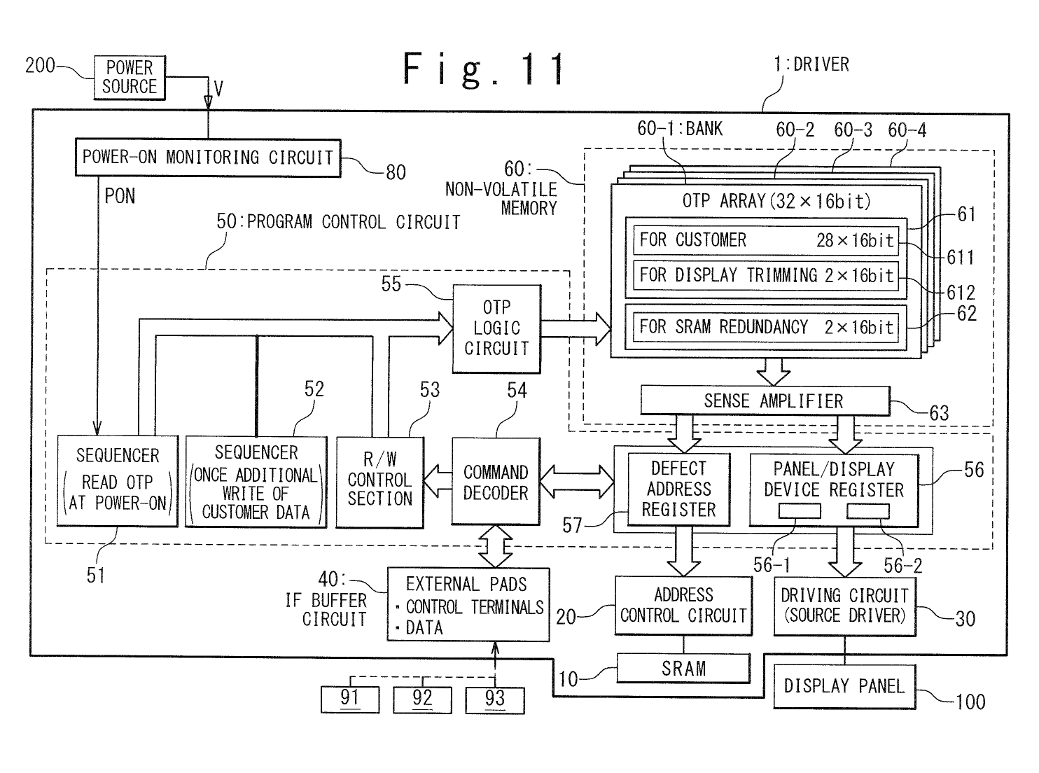

FIG. 11 shows a configuration of the display system to which the driver 1 acceding to the sixth embodiment of the present invention is applied.

Moreover, the driver 1 is further provided with a power-on monitoring circuit 80. The power-on monitoring circuit 80 monitors whether or not the power supply voltage V was supplied from a power source 200 to the driver 1.

The nonvolatile memory 60 represents OTP {One Time PROM (Programmable Read Only The memory)}. The nonvolatile memory 60 includes a plurality of banks 60-1 to 60-4 which are used in this order, and a sense amplifier circuit 63. When this nonvolatile memory 60 is fabricated as a memory chip, the plurality of banks 60-1 to 60-4 and the sense amplifier circuit 63 are fabricated onto an identical memory chip. Here, one of the plurality of banks 60-1 to 60-4, for example, the bank 60-1 is supposed to be valid.

Each of the plurality of banks 60-1 to 60-4 has the storage section of 16×32 bits. The storage section of 16×32 bits is divided into the defect address data storage section 62 of the display quality specifying data storage section 61 of 16×30 bits and the defect address data storage section 62 of 16×2 bits. That is, the display quality specifying data storage section 61 and the defect address data storage section 62 share the sense amplifier circuit 63. The display quality specifying data storage section 61 of 16×30 bits contains a first display quality specifying data storage section 611 of 16×28 bits and a second display quality specifying data storage section 612 of 16×2 bits. For example, the first display quality specifying data storage section w1-1 has 28 storage areas and the second display quality specifying data storage section w1-2 has 2 storage areas. Also, the defect address data storage section 62 of 16×2 bits has 2 storage areas.

The above-mentioned display quality specifying data W1 contains the first display quality specifying data W1-1 of a panel maker who manufactures the display panel 100 and the second display quality specifying data W1-2 of a display device maker who manufactures the driver 1. Therefore, the first display quality specifying data W1-1 is recorded to the first display quality specifying data storage section 611 of the bank 60-1, and the second display quality specifying data W1-2 is recorded to the second display quality specifying data storage section 612 of the bank 60-1. Also, the above-mentioned defect address data W2 is recorded to the defect address data storage section 62 of the bank 60-1.

The program control circuit 50 includes sequencers 51 and 52, a R/W (reed/write) control section 53, a command decoder 54, an OTP logic circuit 55, a panel/display device register 56 and a defect address register 57. The panel/display device register 56 contains a panel register 56-1 and a display device register 56-2. When the power supply voltage V is supplied from the power source 200 to the driver 1, the sequencer 51 outputs a read signal to read the first display quality specifying data W1-1, the second display quality specifying data W1-2, and the defect address data W2 from the first display quality specifying data storage section 611, the second display quality specifying data storage section 612, and the defect address data storage section 62 of the bank 60-1. The sequencer 52 outputs a signal to additionally write customer data (data of the panel maker). However, since the sequencer 52 is not directly related to the present invention, the detailed description of the sequencer 52 is omitted. The R/W control section 53 outputs control signals (read signal, and write signal) to a read instruction, and a write instruction, respectively. The command decoder 54 decodes the inputted read instruction and the write instruction. The OTP logic circuit 55 converts the signals from the sequencers 51 and 52, and the R/W control section 53 into signals suitable for the nonvolatile memory (OTP) 60.

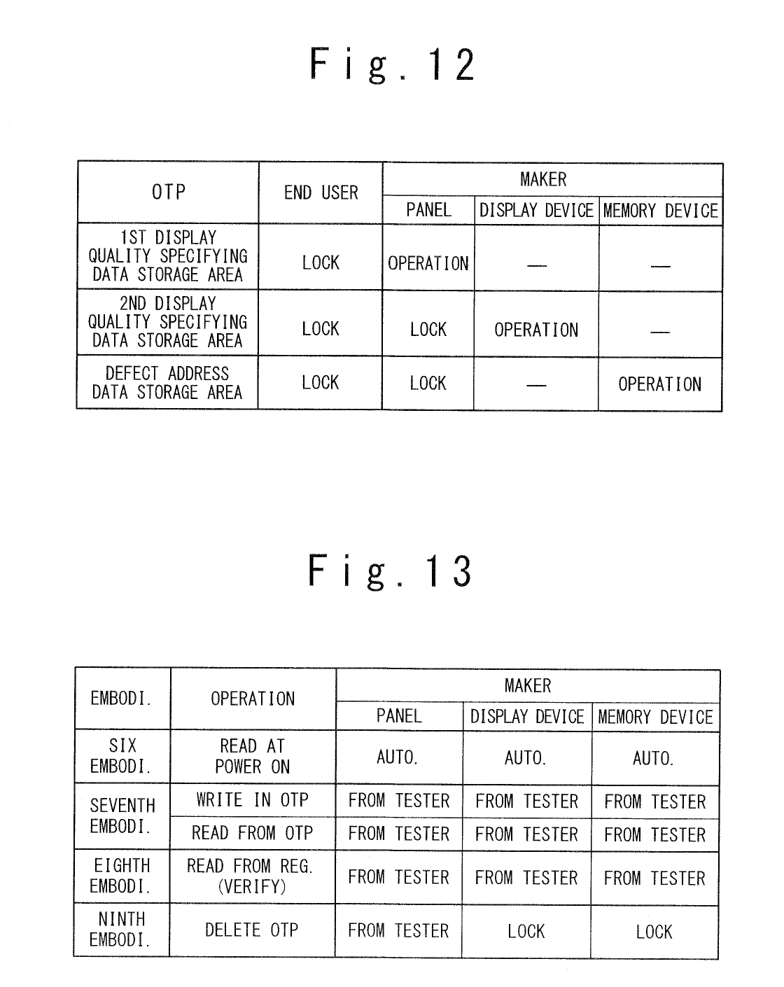

As shown in FIG. 12, the end user (the user) does have the access right to the first display quality specifying data storage section 611, the second display quality specifying data storage section 612, and the defect address data storage section 62 in the bank 60-1, and the panel maker, the display device maker, and the memory 10 maker have access rights to them at the time of the test. That is, the panel maker, the display device maker, and the memory 10 maker can operate the first display quality specifying data storage section 611, the second display quality specifying data storage section 612, and the defect address data storage section 62 at the time of the test. The display device maker and the memory device maker may be a same maker, and for example, the display device maker can be divided into a subdivision to manufacture the driver 1 and a subdivision to manufacture the memory 10.

The memory 10 is composed of SRAM (Static Random Access Memory). In this case, when the power supply voltage V is supplied from the power source 200 to the driver 1, the addresses of defective ones of the memory cells 11 in the memory 10 must be replaced with the addresses of the redundant memory cells 12 based on the defect address data W2. Therefore, as shown in FIG. 13, when the power supply voltage V is supplied to the driver 1 from the power source 200, it is preferable that the driver 1 automatically reads out the first display quality specifying data W1-1, the second display quality specifying data W1-2, and the defect address data W2 from the first display quality specifying data storage section 611, the second display quality specifying data storage section 612, and the defect address data storage section 62 in the bank 60-1.

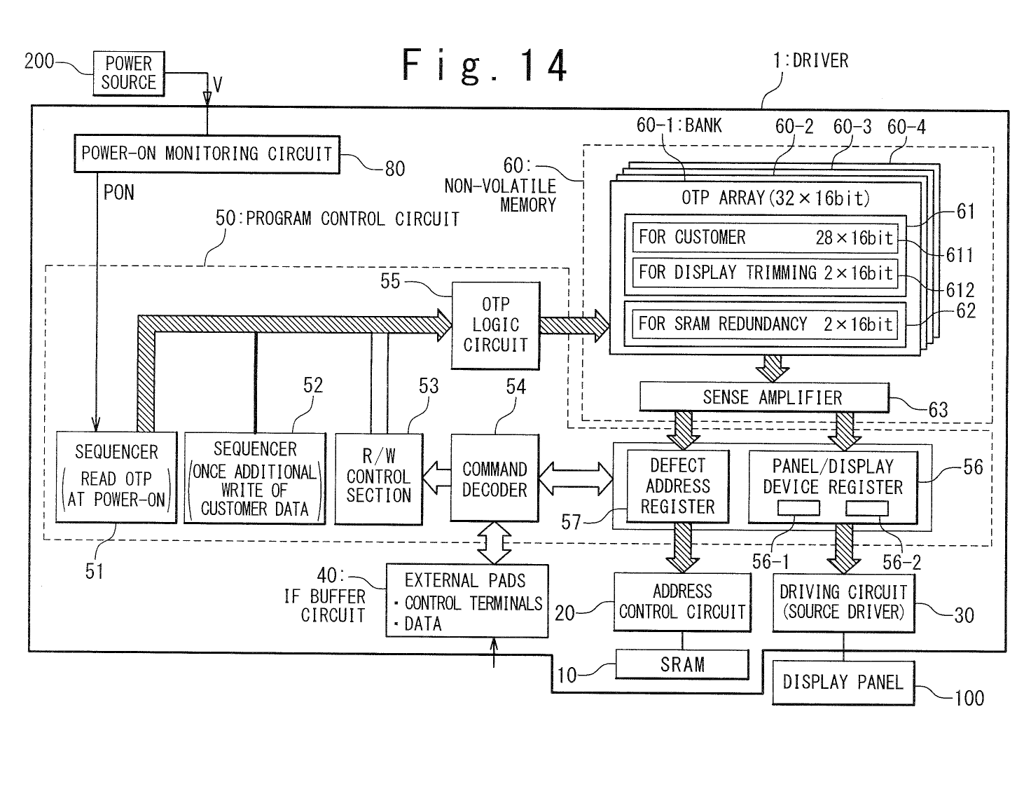

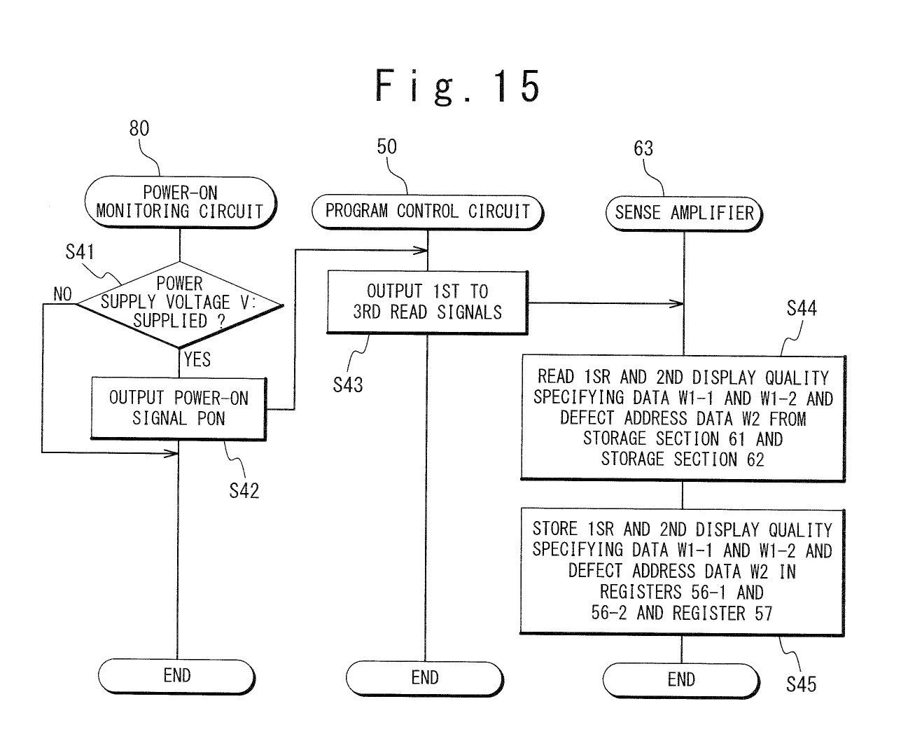

FIG. 14 is a block diagram showing an automatic power-on read operation by the driver 1 according to the sixth embodiment of the present invention, and FIG. 15 is a flow chart showing operations of the power-on monitoring circuit 80, the program control circuit 80, and the sense amplifier circuit 63.

The power-on monitoring circuit 80 monitors the power source 200 (Step S41). When the power supply voltage V is supplied to the driver 1 from the power source 200 (Step S41-YES), the power-on monitoring circuit 80 outputs a power-on signal PON to the sequencer 51 (Step S42). The sequencer 51 outputs first to third read signals to the nonvolatile memory 60 through the OTP logic circuit 55 in response to the power-on signal PON for reading out the first display quality specifying data W1-1, the second display quality specifying data W1-2, and the defect address data W2 from the first and second display quality specifying data storage sections 611 and 612, and the defect address data storage section 62 in the bank 60-1 (Step S43).

The sense amplifier circuit 63 reads out the first and second display quality specifying data W1-1 and W1-2 and the defect address data W2 from the first and second display quality specifying data storage sections 611 and 612, and the defect address data storage section 62 in the bank 60-1 in response to the first to third read signals, respectively (Step S44). The sense amplifier circuit 63 stores the first and second display quality specifying data W1-1 and W1-2 and the defect address data W2 in the panel register 56-1, the display device register 56-2 and the defect address register 57 (Step S45).

The defect address register 57 is referred to by the address control circuit 20. That is, the address control circuit 20 replaces a defective memory cell of the plurality of memory cell 11 with a redundant memory cell 12 based on the defect address data W2 recorded in the defect address data storage section 62. The address control circuit 20 receives display data DL for one display line from the display data DA stored the memory 10 and outputs it to the driving circuit 30.

The panel register 56-1 and the display device register 56-2 are referred to by the driving circuit 30. That is, the driving circuit 30 displays the display data DL on display panel 100 based on the first and second display quality specifying data W1-1 and W1-2 set in the panel register 56-1 and the display device register 56-2.

In this way, according to the driver 1 in the sixth embodiment of the present invention, when the power supply voltage V is supplied to the driver 1 from the power source 200, the driver 1 can automatically read out the first display quality specifying data W1-1, the second display quality specifying data W1-2 and the defect address data W2 from the first display quality specifying data storage section 611, the second display quality specifying data storage section 612, and the defect address data storage section 62 in the bank 60-1.

### Seventh Embodiment

In the description of the seventh embodiment, duplicate description with the above-mentioned first to sixth embodiments is omitted.

In the seventh embodiment, the panel maker, the display device maker, and the memory device maker perform tests using testers to carry out image adjustment, image/circuit adjustment, and circuit (memory 10) adjustment, respectively. In this case, as shown in FIG. 13, a check is carried out of whether the first display quality specifying data W1-1, the second display quality specifying data W1-2, and the defect address data W2 are written in the first display quality specifying data storage section 611, the second display quality specifying data storage section 612, and the defect address data storage section 62 in the bank 60-1 by the panel maker, the display device maker, and the memory device maker at the time of tests. Also, a check is carried out whether the first display quality specifying data W1-1, the second display quality specifying data W1-2, and the defect address data W2 are read out from the first display quality specifying data storage section 611, the second display quality specifying data storage section 612, and the defect address data storage section 62 in the bank 60-1 by the panel maker, the display device maker, the memory device maker at the time of the tests.

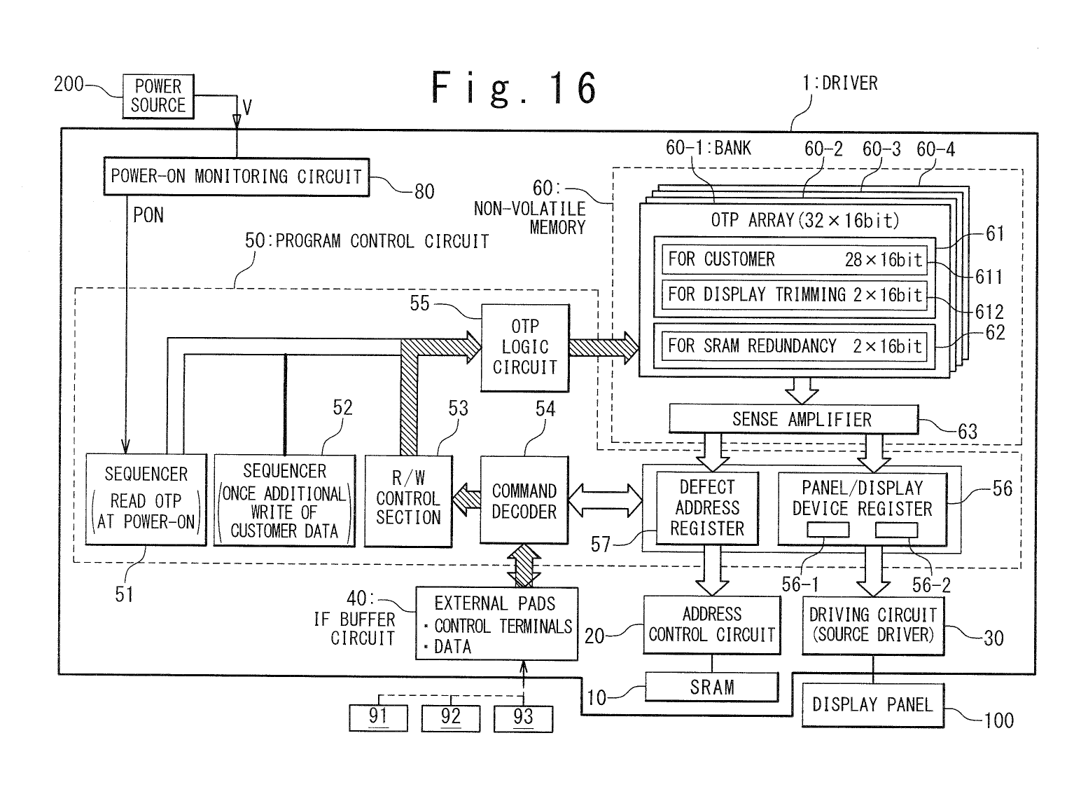

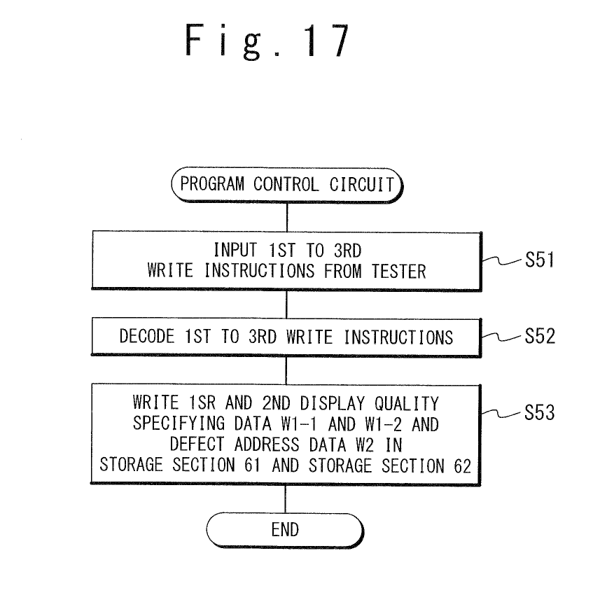

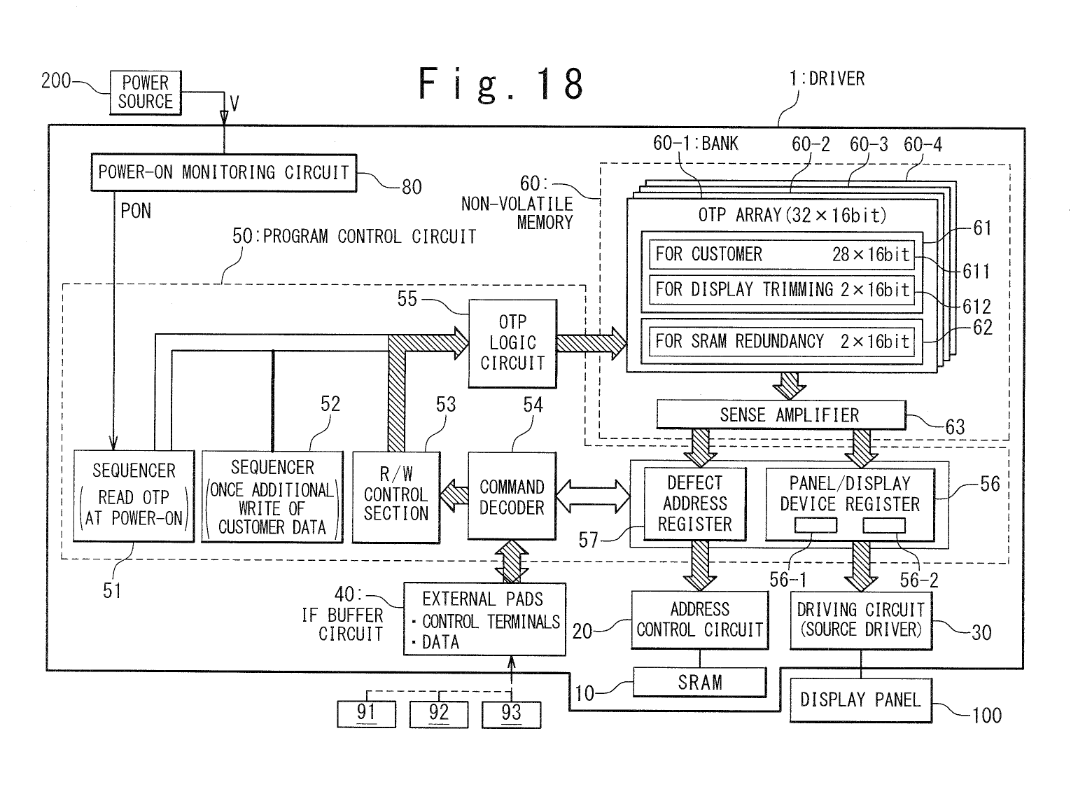

FIG. 16 is a diagram showing a write operation of the driver 1 according to the seventh embodiment of the present invention, and FIG. 17 is a flow chart showing the operation of the program control circuit 50 of FIG. 16.

As described above, the panel maker, the display device maker, the memory device maker use testers at the time of the test, respectively. To distinguish the testers used by the panel maker, the display device maker, the memory device maker, respectively, they are referred to first to third testers 91 to 93. The panel maker, the display device maker, the memory device maker input first to third write instructions from the testers 91 to 93 to the command decoder 54 of program control circuit 50 through the IF buffer circuit 40 (Step S51). The first to third write instructions contain the first and second display quality specifying data W1-1 and W1-2 and the defect address data W2 and addresses of the first and second display quality specifying data storage sections 611 and 612, and an address of the defect address data storage section 62 in the bank 60-1.

The command decoder 54 decodes the first to third write instructions (Step S52). The control section 53 writes the first and second display quality specifying data W1-1 and W1-2 and the defect address data W2 in the first and second display quality specifying data storage sections 612 and 612, and the defect address data storage section 62 in the bank 60-1 through the OTP logic circuit in response to the first to third write instructions decoded by the command decoder 54 (Step S53).

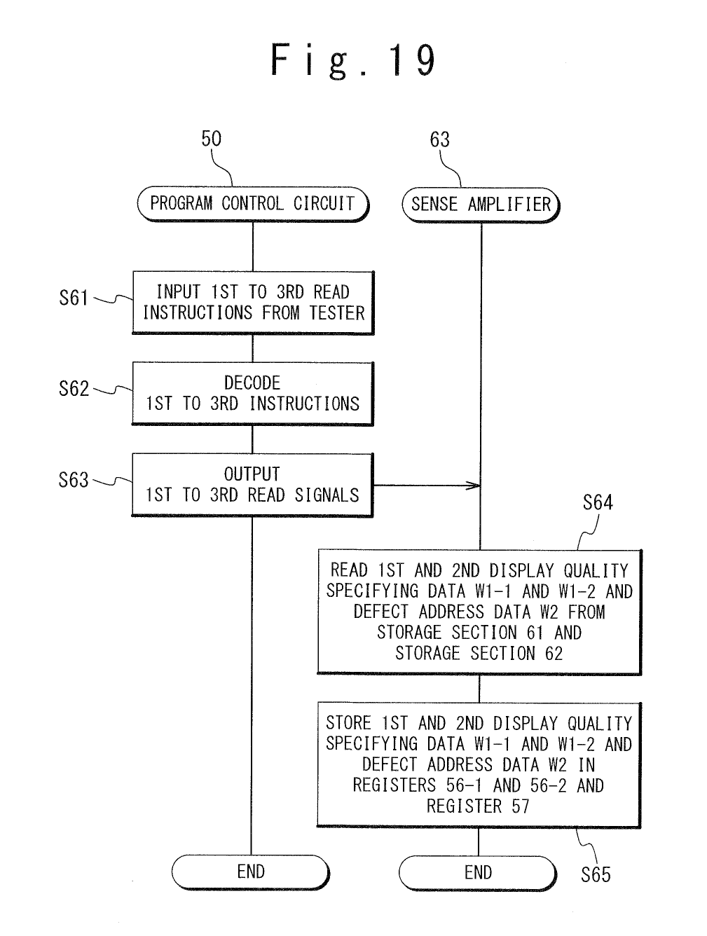

FIG. 18 is a diagram showing a read operation of the driver 1 according to the seventh embodiment of the present invention and FIG. 19 is a flow chart showing the operation of the program control circuit 50 and the sense amplifier circuit 63 in FIG. 18.

The panel maker, the display device maker, and the memory device maker receive the first to third read instructions from the testers 91 to 93 by the command decoder 54 of the program control circuit 50 through the IF buffer circuit 40 (Step S61). The first to third read instructions contains the first and second display quality specifying data W1-1 and W1-2 and the defect address data W2 together with addresses of the first and second display quality specifying data storage sections 611 and 612, and the defect address data storage section 62 in the bank 60-1.

The command decoder 54 decodes the first to third read instructions (Step S62). The control section 53 outputs first to third read signals to the nonvolatile memory 60 through the OTP logic circuit in response to the first to third read instructions decoded by the command decoder 54 (Step S63). The sense amplifier circuit 63 outputs the first and second display quality specifying data W1-1 and W1-2 and the defect address data W2 read out from the first and second display quality specifying data storage sections 611 and 612 and the defect address data storage section 62 in the bank 60-1 in response to the first to third read signals (Step S64). The sense amplifier circuit 63 stores the first and second display quality specifying data W1-1 and W1-2 and the defect address data W2 in the panel register 56-1, the display device register 56-2 and the defect address register 57, respectively (Step S65).

The defect address register 57 is referred to by the address control circuit 20. That is, the address control circuit 20 replaces a defective memory cell of the plurality of memory cells 11 with a redundant memory cell 12 based on the defect address data W2 set to the defect address data storage section 62, like the usual redundant operation. The address control circuit 20 outputs display data DL for one display line to the driving circuit 30 from the display data DA stored in the memory 10. The panel register 56-1 and the display device register 56-2 are referred to by the driving circuit 30. That is, the driving circuit 30 displays the display data DL on the display panel 100 based on the first and second display quality specifying data W1-1 and W1-2 set in the panel register 56-1 and the display device register 56-2.

In this way, according to the driver 1 according to the seventh embodiment of the present invention, the panel maker, the display device maker, and the memory device maker can check whether the first display quality specifying data W1-1, the second display quality specifying data W1-2, and the defect address data W2 are written in the first display quality specifying data storage section 611, the second display quality specifying data storage section 612, and the defect address data storage section 62 in the bank 60-1 at the time of the tests, respectively. Also, the panel maker, the display device maker, the memory device maker can check whether the first display quality specifying data W1-1, the second display quality specifying data W1-2, and the defect address data W2 are read out from the first display quality specifying data storage section 611, the second display quality specifying data storage section 612, and the defect address data storage section 62 in the bank 60-1 at the time of the tests, respectively.

### Eighth Embodiment

In the description of the eighth embodiment, duplicate description with the above-mentioned first to seventh embodiments will be omitted.

In the above-mentioned seventh embodiment, the panel maker, the display device maker, and the memory device maker read out the first display quality specifying data W1-1, the second display quality specifying data W1-2 and the defect address data W2 from the first display quality specifying data storage section 611, the second display quality specifying data storage section 612, and the defect address data storage section 62 in the bank 60-1 at the time of the tests, respectively.

On the other hand, in the eighth embodiment, as shown in FIG. 13, it is preferable that the panel maker, the display device maker, and the memory device maker check whether the first display quality specifying data W1-1, the second display quality specifying data W1-2, and the defect address data W2 read out from the first display quality specifying data storage section 611, the second display quality specifying data storage section 612, and the defect address data storage section 62 in the bank 60-1 are set in the panel register 56-1, the display device register 56-2 and the defect address register 57 at the time of the tests, respectively.

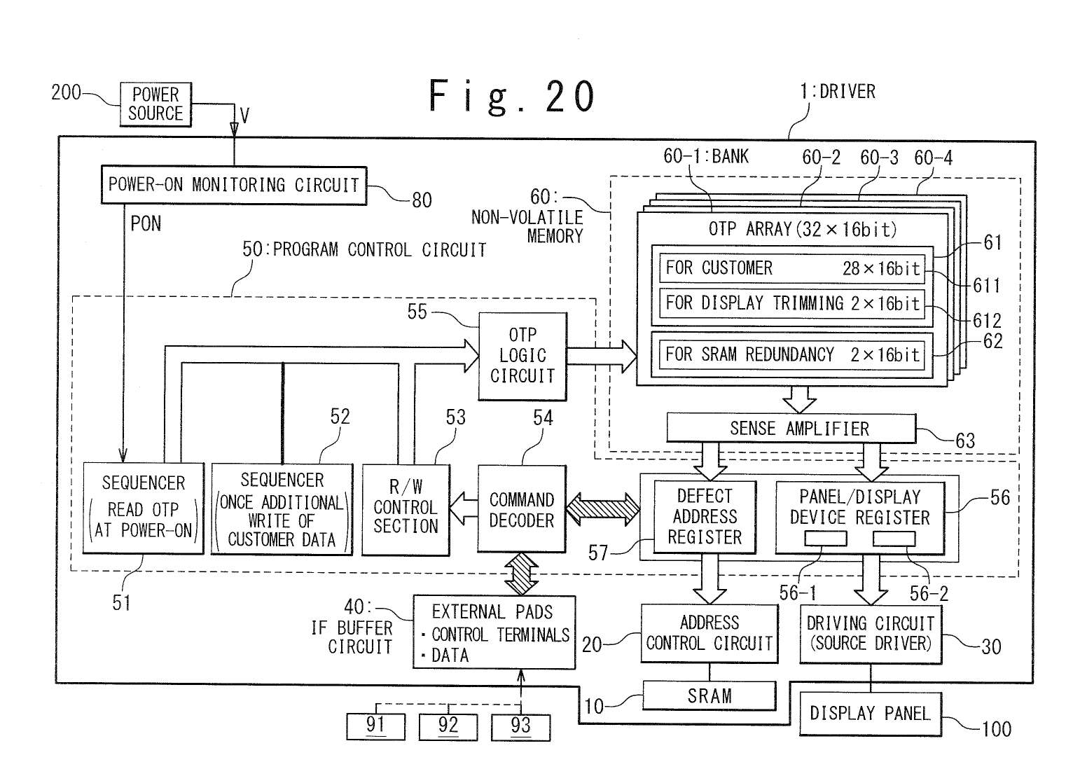

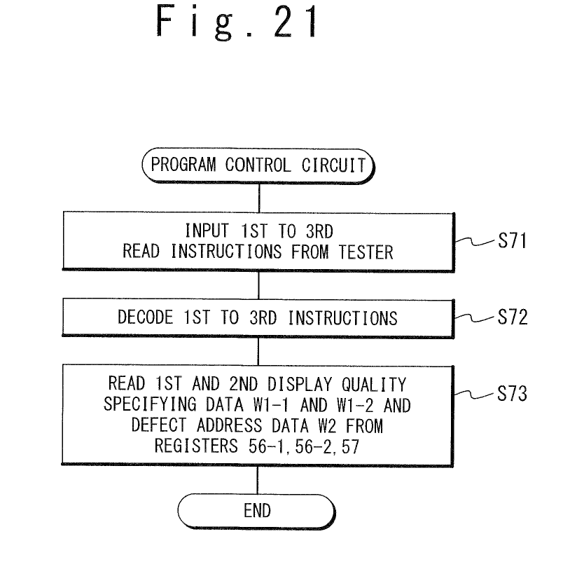

FIG. 20 is a block diagram showing a read operation of the driver 1 according to the eighth embodiment of the present invention and FIG. 21 is a flow chart showing the operation of the program control circuit 50 of FIG. 20.

The panel maker, the display device maker, and the memory device maker input first to third register read instructions to the command decoder 54 in the program control circuit 50 through the IF buffer circuit 40 from the testers 91 to 93, respectively (Step S71). The first to third register read instructions contain the addresses of the panel register 56-1, the display device register 56-2 and the defect address register 57, respectively.

The command decoder 54 decodes the first to third register read instructions (Step S72). The control section 53 reads the first and second display quality specifying data W1-1 and W1-2 and the defect address data W2 from the panel register 56-1, the display device register 56-2 and the defect address register 57 in response to the first to third register read instructions decoded by the command decoder 54, respectively. The control section 53 outputs the first and second display quality specifying data W1-1 and W1-2 and the defect address data W2 to the testers 91 to 93, respectively (Step S73).

In this way, according to the driver 1 by the 8th embodiment of the present invention, the panel maker, the display device maker, and the memory device maker can check whether the first display quality specifying data W1-1, the second display quality specifying data W1-2, and the defect address data W2 read out from the first display quality specifying data storage section 611, the second display quality specifying data storage section 612, and the defect address data storage section 62 in the bank 60-1 have been set in the panel register 56-1, the display device register 56-2 and the defect address register 57, at the time of the tests, respectively.

### Ninth Embodiment

In the description of the ninth embodiment, duplicate description with those of the first to eighth embodiments will be omitted.

In the above-mentioned sixth to eighth embodiments, it is sometimes desired to erase the data of the bank 60-1 of the plurality of banks 60-1 to 60-4 in the nonvolatile memory 60. However, when the nonvolatile memory 60 is OTP, it is not possible to erase electrically. In the ninth embodiment, the panel maker changes between the bank 60-1 and the bank 60-2 and uses the bank 60-2 instead of the bank 60-1 for the erasure of the data of the bank 60-1 at the time of the test.

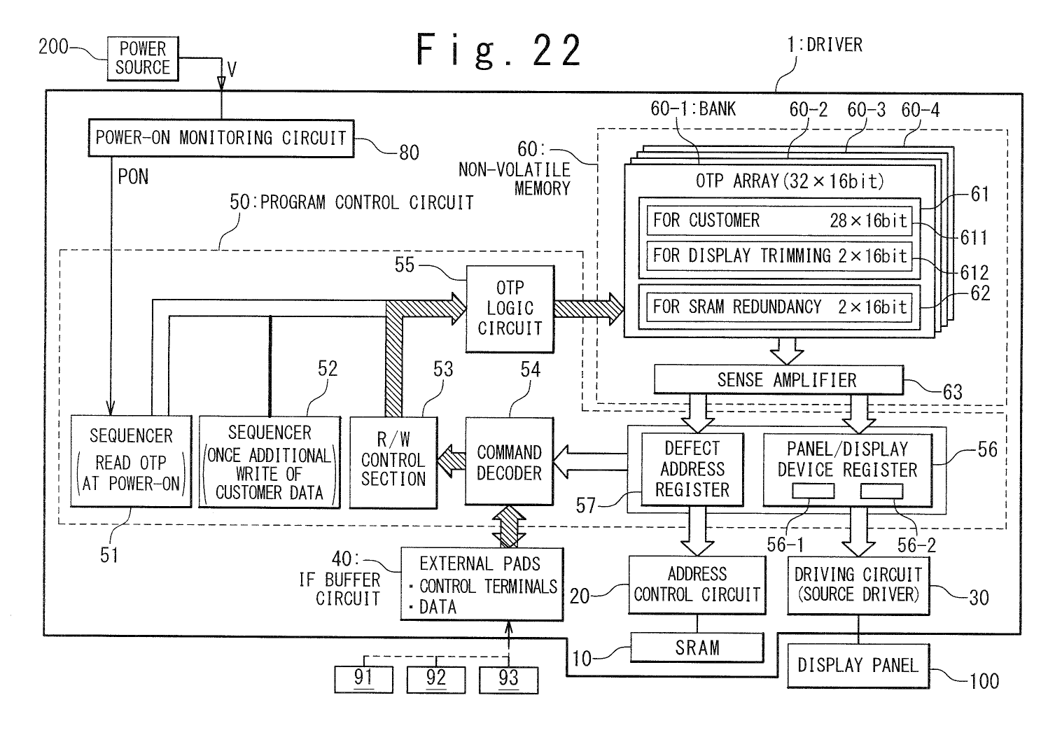

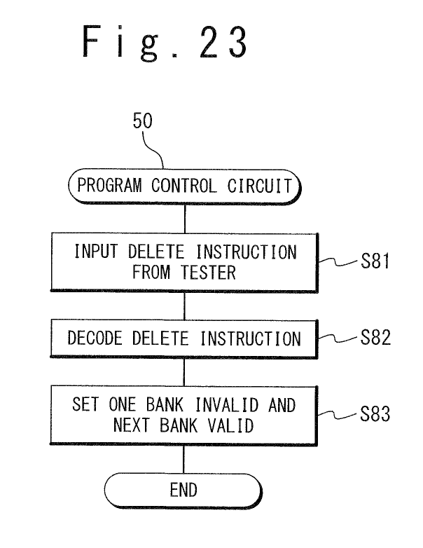

FIG. 22 is a block diagram showing an erase operation of the driver 1 according to the ninth embodiment of the present invention and FIG. 23 is a flow chart showing the operation of the program control circuit 50 of FIG. 22.

The panel maker inputs an erase instruction to the command decoder 54 of the program control circuit 50 through IF buffer circuit 40 from tester 91 to erase the data of the bank 60-1 valid at present (Step S81). The command decoder 54 decodes the erase instruction (Step S82). The control section 53 makes the bank 60-1 invalid and then makes the bank 60-2 in the plurality of banks 60-1 to 60-4 valid, in response to the erase instruction decoded by the command decoder 54. That is, the valid bank is switched from the bank 60-1 to the bank 60-2 (Step S83). Thus, the first and second display quality specifying data W1-1 and W1-2 and the defect address data W2 can be recorded in the first and second display quality specifying data storage sections 611 and 612, and the defect address data storage section 62 in the bank 60-2.

In this way, when the panel maker inputs the erase instruction for the first time by using the tester 91, the bank 60-1 is made invalid and then the bank 60-2 is made valid. In the same way, when the panel maker inputs the erase instruction for the second time by using the tester 91, the bank 60-2 is made invalid and then the bank 60-3 is made valid. In the same way, when the panel maker inputs the erase instruction for the third time by using the tester 91, the bank 60-3 is made invalid and then the bank 60-4 is made valid. In the driver 1 according to the ninth embodiment of the present invention, the number of banks is 4 and the bank is erasable three times. However, the present invention is not limited to this. By increasing the number of banks, the number of times of the erase operation can be increased.

According to the driver 1 according to the ninth embodiment of the present invention, when the nonvolatile memory 60 is OTP, the panel maker can use the substitution of the bank for the erase operation of the bank at the time of the test.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A driver comprising:
a first memory which comprises a plurality of memory cells and redundant memory cells;
an address control circuit configured to replace a defective memory cell of said plurality of memory cells with one of said redundant memory cells based on a defect address data indicating an address of the defective memory cell;
a driving circuit configured to display on a display panel, a display data stored in said first memory based on a display quality specifying data specifying display quality of the display panel; and
a second memory in which said display quality specifying data and said defect address data are stored.

2. The driver according to claim 1, further comprising a program control circuit,
wherein said second memory has a display quality specifying data storage section and a defect address data storage section, and
said program control circuit stores said display quality specifying data in said display quality specifying data storage section, and
when said plurality of memory cells are tested, and at least one of said plurality of memory cells is the defective memory cell, said program control circuit stores said defect address data in said defect address data storage section.

3. The driver according to claim 2, wherein said second memory comprises any of a flash memory, an EPROM {Erasable Programmable ROM (Read Only The memory)}, and an EEPROM (Electrically Erasable Programmable ROM) as a nonvolatile memory.

4. The driver according to claim 2, wherein said second memory comprises at least an electric fuse group as a nonvolatile memory.

5. The driver according to claim 4, wherein each of said display quality specifying data storage section and said defect address data storage section contains said electric fuse group, and
said program control circuit supplies an electric current to electric fuses to be cut in said electric fuse group of said display quality specifying data storage section to store said display quality specifying data in said display quality specifying data storage section, and supplies an electric current to electric fuses to be cut in said electric fuse group of said defect address data storage section to store said defect address data in said defect address data storage section.

6. The driver according to claim 2, further comprising:
a BIST (Built-In Self-Test) circuit configured to test each of said plurality of memory cells, and to output said defect address data to said program control circuit when at least one of said plurality of memory cells is the defective memory cell.

7. The driver according to claim 6, further comprising:
a power-on monitoring circuit configured to monitor a power supply, and to output a power-on signal to said BIST circuit when a power supply voltage from said power supply is detected, and
wherein said BIST circuit starts the test in response to the power-on signal.

8. The driver according to claim 2, wherein the display quality indicated based on said display quality specifying data is changeable by a user, and
said program control circuit holds an access right to said display quality specifying data storage section, and when an instruction which contains a display quality change data and a command is given by the user, and said command and said held access right are coincident with each other, accesses said display quality specifying data storage section to change said display quality specifying data based on said display quality change data.

9. The driver according to claim 2, wherein said display quality specifying data contains a first display quality specifying data on a panel maker and a second display quality specifying data on a display device maker who manufactures said driver, and
said display quality specifying data storage section comprises a first display quality specifying data storage section in which said first display quality specifying data is stored, and a second display quality specifying data storage section in which said second display quality specifying data is stored.

10. The driver according to claim 9, further comprising:
a power-on monitoring circuit configured to monitor a power supply and to output a power-on signal when the power supply voltage is detected from said power supply,
said program control circuit comprises:
a sequencer configured to output first to third read signals to said second memory in response to the power-on signal;
a panel register and a display device register which are referred to by said driving circuit; and
a defect address register which is referred to by said address control circuit, and
said second memory further comprises:
a sense amplifier configured to read out said first and second display quality specifying data and said defect address data from said first and second display quality specifying data storage sections and said defect address data storage section in response to said first to third read signals, to store in said panel register, said display device register and said defect address register, respectively.

11. The driver according to claim 10, wherein the panel maker, the display device maker, and a memory device maker who manufactures said first memory input first to third write instructions which contain said first and second display quality specifying data and said defect address data, and addresses of said first and second display quality specifying data storage sections and said defect address data storage section by using first to third testers in tests, respectively, and
said program control circuit comprises:
a command decoder configured to decode the first to third write instructions; and
a control unit configured to write said first and second display quality specifying data and said defect address data in said first and second display quality specifying data storage sections and said defect address data storage section in response to said first to third write instructions decoded by said command decoder, respectively.

12. The driver according to claim 11, wherein the panel maker, the display device maker, and the memory device maker input first to third read instructions which contain said first and second display quality specifying data and said defect address data, and addresses of said first and second display quality specifying data storage sections and said defect address data storage section, by using said first to third testers in the tests, respectively,
said command decoder decodes said first to third read instructions,
said control unit outputs said first to third read signals to said second memory based on said thirst to third read instructions decoded by said command decoder, respectively, and
said sense amplifier reads said first and second display quality specifying data and said defect address data from said first and second display quality specifying data storage sections and said defect address data storage section to store in said panel register, said display device register and said defect address register in response to said first to third read signals, respectively.

13. The driver according to claim 12, wherein the panel maker, the display device maker, and the memory device maker input first to third register read instructions which contain addresses of said panel register, said display device register and said defect address register, by using said first to third testers in the tests, respectively,
said command decoder decodes said first to third register read instructions, and reads out said first and second display quality specifying data and said defect address data from said panel register, said display device register and said display device register, to output to said first to third testers in response to said first to third register read instructions, respectively.

14. The driver according to claim 11, wherein said second memory is OTP {One Time PROM (Programmable Read Only Memory)} as a nonvolatile memory.

15. The driver according to claim 14, wherein said second memory comprises a plurality of banks which are sequentially used,
each of said plurality of banks has said first and second display quality specifying data storage sections and said defect address data storage section,
the panel maker inputs an erase instruction to erase a currently valid bank of said plurality of banks using said first tester,
said command decoder decodes said erase instruction,
said control unit makes said currently valid bank invalid and a next bank of said plurality of banks valid in response to said decoded erase instruction, and
said first and second display quality specifying data and said defect address data are respectively stored in said first and second display quality specifying data storage sections and said defect address data storage section in said next bank.

16. The driver according to claim 10, wherein said first memory comprises an SRAM (Static Random Access The memory).

17. The driver according to claim 1, wherein said second memory comprises:
a storage section in which said display quality specifying data is stored; and
a storage section in which said defect address data is stored, and
said display quality specifying data storage section and said defect address data storage section are provided on a same memory chip.

18. The driver according to claim 17, wherein said memory chip further comprises:
a sense amplifier shares said display quality specifying data storage section and said defect address data storage section.

19. A display apparatus comprising:
a display panel; and
a driver which comprises:
a first memory which comprises a plurality of memory cells and redundant memory cells;
an address control circuit configured to replace a defective memory cell of said plurality of memory cells with one of said redundant memory cells based on a defect address data indicating an address of the defective memory cell;
a driving circuit configured to display on said display panel, a display data stored in said first memory based on a display quality specifying data specifying display quality of the display panel; and
a second memory in which said display quality specifying data and said defect address data are stored.

20. A display method of displaying a display data stored in a first memory on a display panel by using a driver which comprises memory cells and redundant memory cells, said display method comprising:
storing a display quality specifying data and a defect address data indicating an address of a defective one of said memory cells, in a second memory;
replacing said defective memory cell with one of said redundant memory cells based on said defect address data;
displaying said display data based on said display quality specifying data on said display panel.
